(19) United States
(12) Patent Application Publication
(10) Pub. No.: US 2026/0353124 A1
(43) Pub. Date: Nov. 5, 2026

(54) AIML MOBILITY - ENHANCED RRM MEASUREMENT PREDICTION REPORTING

(71) Applicant: InterDigital Patent Holdings, Inc., Wilmington, DE (US)

(72) Inventors: Aristeidis Seretis, Outremont (CA); Oumer Teyeb, Montreal (CA); Ahmed Mostafa, Ottawa (CA); Yugeswar Deenoo Narayanan Thangaraj, Chalfont, PA (US); Patrick Tooher, Montreal (CA)

(73) Assignee: InterDigital Patent Holdings, Inc., Wilmington, DE (US)

(21) Appl. No.: 19/199,169

(22) Filed: May 5, 2025

(51) Int. Cl. H04W 24/08; H04W 8/22; H04W 24/02

(52) U.S. Cl. CPC H04W 24/08; H04W 8/22; H04W 24/02

(57) ABSTRACT

A wireless transmit/receive unit (WTRU) may receive reporting configuration information. The reporting configuration information may comprises one or more radio resource management (RRM) measurement thresholds associated with RRM measurements. The reporting configuration information may comprises one or more RRM measurement prediction thresholds associated with RRM measurement predictions. The WTRU may determine a plurality of RRM measurements and a plurality of RRM measurement predictions. The WTRU may determine a reporting periodicity and/or a reporting offset based on the plurality of RRM measurements, the plurality of RRM measurement predictions, the one or more RRM measurement thresholds, and/or the one or more RRM measurement prediction thresholds. The WTRU may send, based on the reporting periodicity and the reporting offset, a report comprising the at least a subset of the plurality of RRM measurements or at least a subset of the plurality of RRM measurement predictions.

### BACKGROUND

A Release (Rel)-19 radio access network 2 (RAN2) study item (SI) on artificial intelligence or machine learning (AIML) mobility enhancements has been approved. The main cases may include radio resource management (RRM) measurement prediction and/or measurement event prediction. The study of the use cases is driven mainly by two study goals.

The first study goal is measurement reduction. This goal aims to reduce measurement efforts in temporal, spatial, and/or frequency domain by using predicted measurements.

The second study goal is improve handover (HO) performance. This goal aims to improve system and/or user equipment (UE), also known as a wireless transmit/receive unit (WTRU), level performance (e.g., preventing and/or reducing ping-pong HOs, handover failures (HOFs), radio link failures (RLFs), and/or short time of stay in a cell, reduce handover interruption time, etc.) by using predicted measurement reports and/or events.

### SUMMARY

A wireless transmit/receive unit (WTRU) may receive reporting configuration information. The reporting configuration information may comprise one or more radio resource management (RRM) measurement thresholds associated with RRM measurements. The reporting configuration information may comprise one or more RRM measurement prediction thresholds associated with RRM measurement predictions. The WTRU may determine a plurality of RRM measurements and a plurality of RRM measurement predictions. The WTRU may determine a reporting periodicity and/or a reporting offset based on the plurality of RRM measurements, the plurality of RRM measurement predictions, the one or more RRM measurement thresholds, and/or the one or more RRM measurement prediction thresholds. The WTRU may send, based on the reporting periodicity and the reporting offset, a report comprising at least a subset of the plurality of RRM measurements or at least a subset of the plurality of RRM measurement predictions.

The reporting configuration information may comprise an indication of a maximum number of RRM measurements and/or RRM measurement predictions to include in the report. The WTRU may determine the subset of the plurality of RRM measurements or the subset of the plurality of RRM measurement predictions based on the indication of the maximum number of RRM measurements and RRM measurement predictions to include in the report.

The reporting configuration information may comprise an indication of a maximum number of cells to report. The WTRU may determine a subset of cells to report RRM measurements or RRM measurement predictions based on the maximum number of cells. The subset of the plurality of RRM measurements or the subset of the plurality of RRM measurement predictions may be RRM measurements and/or RRM measurement predictions of the subset of cells.

The reporting configuration information comprises an indication of a maximum number of beams to report. The WTRU may determine a subset of beams to report RRM measurements and/or RRM measurement predictions based on the maximum number of beams. The subset of the plurality of RRM measurements or the subset of the plurality of RRM measurement predictions may be RRM measurements and/or RRM measurement predictions of the subset of beams.

The reporting configuration information may comprise a cell quality threshold. The subset of the plurality of RRM measurements or the subset of the plurality of RRM measurement predictions may be based on the cell quality threshold.

The reporting configuration information may comprise a statistical variation of the one or more RMR measurement predictions. The WTRU may determine the subset of the plurality of RRM measurements or the subset of the plurality of RRM measurement predictions based on the statistical variation of the one or more RMR measurement predictions.

The reporting configuration may comprise an explicit configuration of the one or more RMR measurements or the one or more RMR measurement predictions. The WTRU may determine the subset of the plurality of RRM measurements or the subset of the plurality of RRM measurement predictions based on the statistical variation of the one or more RMR measurement predictions.

The WTRU may indicate an increase in the reporting periodicity when the difference of two or more of the plurality of RRM measurements is greater than the one or more RRM measurement thresholds, and/or the difference of two or more of the plurality of RRM measurement predictions is greater than one of the one or more RRM measurement prediction thresholds. The WTRU may indicate a decrease in the reporting periodicity when the difference of two or more of the plurality of RRM measurements is less than the one and/or more RRM measurement thresholds, or the difference of two or more of the plurality of RRM measurement predictions is less than one of the one or more RRM measurement prediction thresholds.

The WTRU may indicate an increase in the reporting offset when the difference of two or more of the plurality of RRM measurements is greater than the one or more RRM measurement thresholds, and/or the difference of two or more of the plurality of RRM measurement predictions is greater than one of the one or more RRM measurement prediction thresholds. The WTRU may indicate a decrease in the reporting offset when the difference of two or more of the plurality of RRM measurements is less than the one and/or more RRM measurement thresholds, or the difference of two or more of the plurality of RRM measurement predictions is less than one of the one or more RRM measurement prediction thresholds.

The WTRU may send, with the report, an indication of one or more RMR measurements of the subset of the plurality of RMR measurements and one or more RMR measurement predictions of the subset of the plurality of RMR measurement predictions measurement reporting that were skipped. The WTRU may send an indication indicating the reason the reporting of the one or more RMR measurements of the subset of the plurality of RMR measurements and one or more RMR measurement predictions of the subset of the plurality of RMR measurement predictions measurement reporting that were skipped.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of intra-frequency temporal domain case A.

FIG. 3 depicts an example of intra-frequency temporal domain case B.

FIG. 4 depicts another example of intra-frequency temporal domain case B.

FIG. 5 depicts a corresponding high-level (NR) measurement model.

FIG. 6 depicts the availability of RRM measurements and predictions for the current reporting time of tₙ for cell A.

FIG. 7 depicts the RRM measurement results for cell A at the reporting time instance of tₙ.

### DETAILED DESCRIPTION

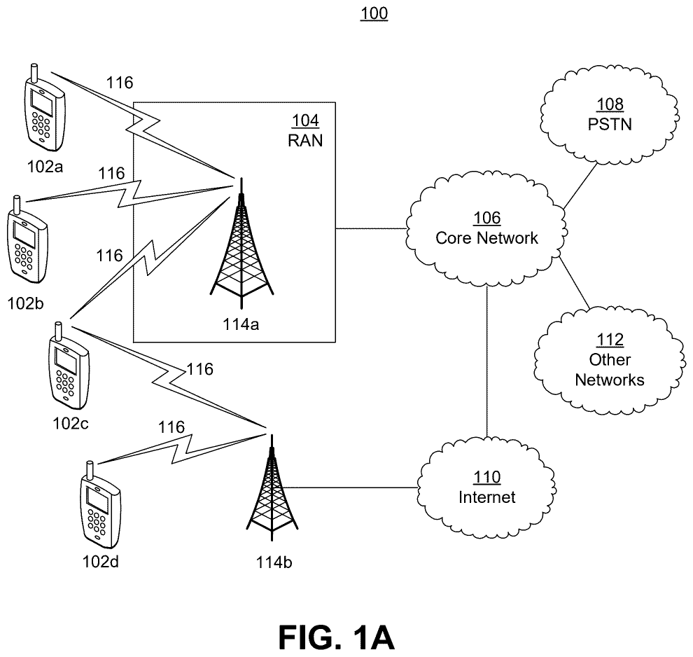

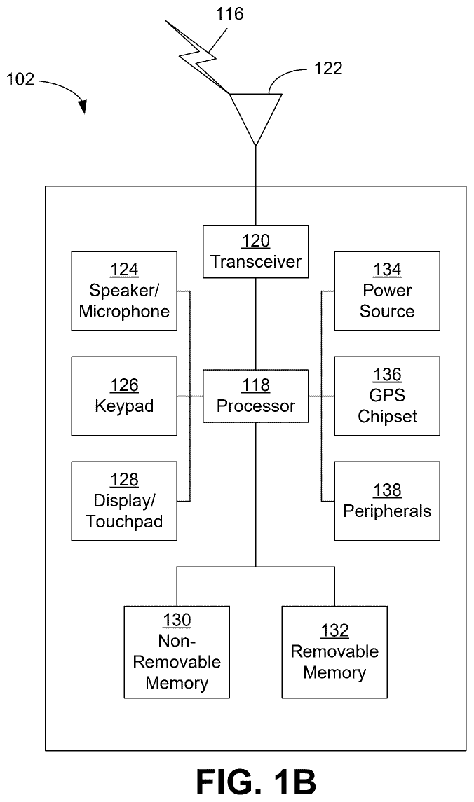

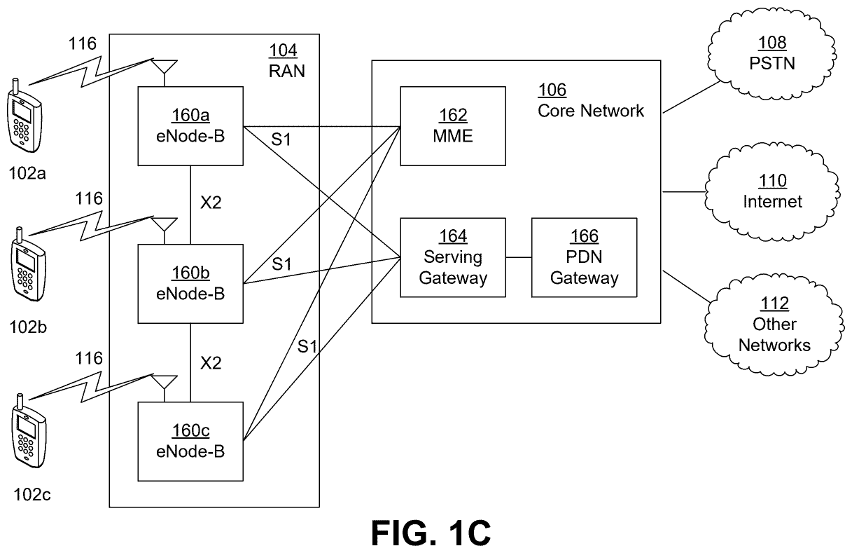

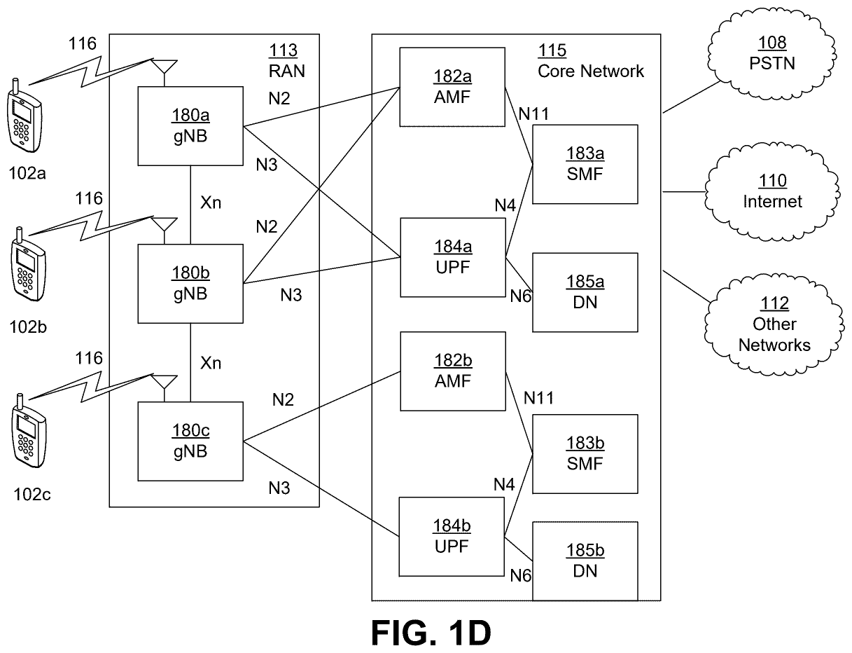

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Radio resource management (RRM) measurement prediction may be performed on a cell-level as well as on a beam-level. For the case of cell-level RRM measurement prediction, three sub-use cases may be considered. Sub-use case 1: L1 beam-level measurement result(s) may be predicted based on actual L1 beam-level measurement result(s), and then L3 cell-level measurement result is generated. Sub-use case 2: L3 cell-level measurement result(s) may be predicted based on actual L3 cell-level measurement result(s). Sub-use case 3: L3 cell-level measurement result(s) may be predicted based on actual L1 beam-level measurement result(s).

For the case of beam-level RRM measurement prediction, three additional sub-use cases may be considered: sub-use case 4: L1 filtered beam-level measurement result(s) may be predicted based on actual L1 beam-level measurement result(s) and then L3 beam-level measurement result is generated. Sub-use case 5: L3 beam-level measurement result(s) may be predicted based on actual L3 beam-level measurement result(s). Sub-use case 6: L3 beam-level measurement result(s) may be predicted based on actual L1 beam-level measurement result(s).

Measurement prediction accuracy for cell-level RRM measurement prediction may be defined as average L3 RSRP difference between predicted L3 filtered cell-level measurement result and actual L3 filtered cell-level measurement result of the same cell for all RRM sub-use cases.

Measurement reduction rate for intra-frequency scenario may be defined in the temporal domain (called MRRT) by assuming same length of measurement time instances and spatial domain respectively (called MRRS). More specifically, MRRT may be defined as a skipped measurement time instances/total measurement time instances. MRRS may be defined as skipped beams to be measured/total beams to be measured.

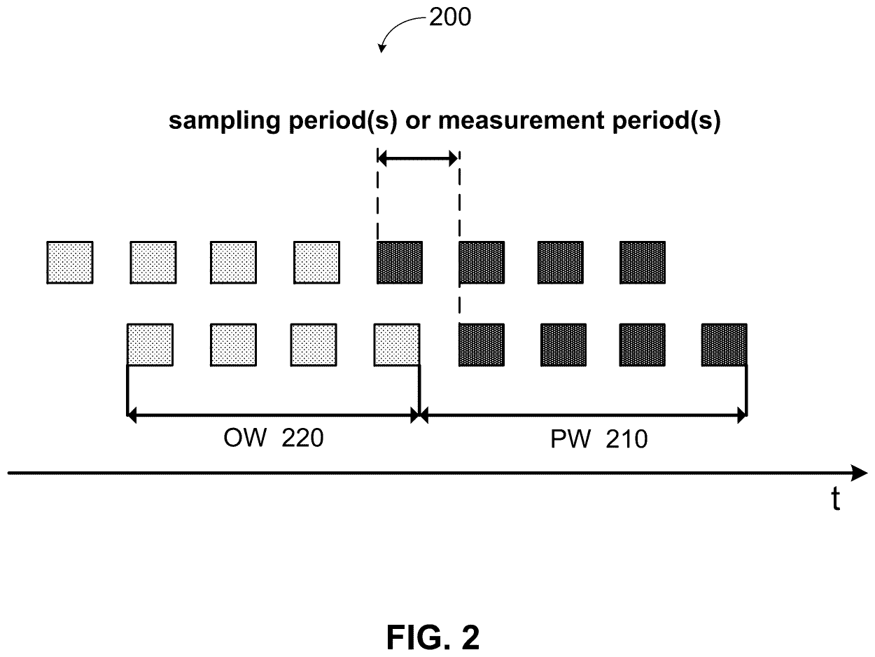

FIG. 2 depicts an example of intra-frequency temporal domain case A 200. In intra-frequency temporal domain case A 200, a continuous measurement may result in the prediction window (PW) 210 predicted by continuous historical measurement result(s) in an observation window (OW) 220. Then both OW 220 and/or PW 210 may slide forward with either sampling period(s) (e.g., with sliding L1/L3 filtering option) or measurement period(s) (e.g., with non-sliding L1/L3 filtering option), where measurement result(s) may be actually measured before sliding.

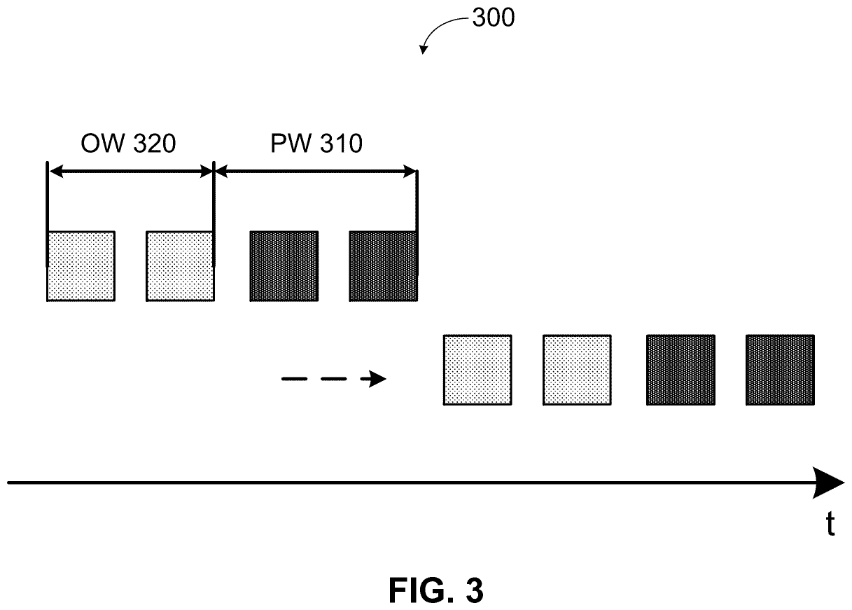

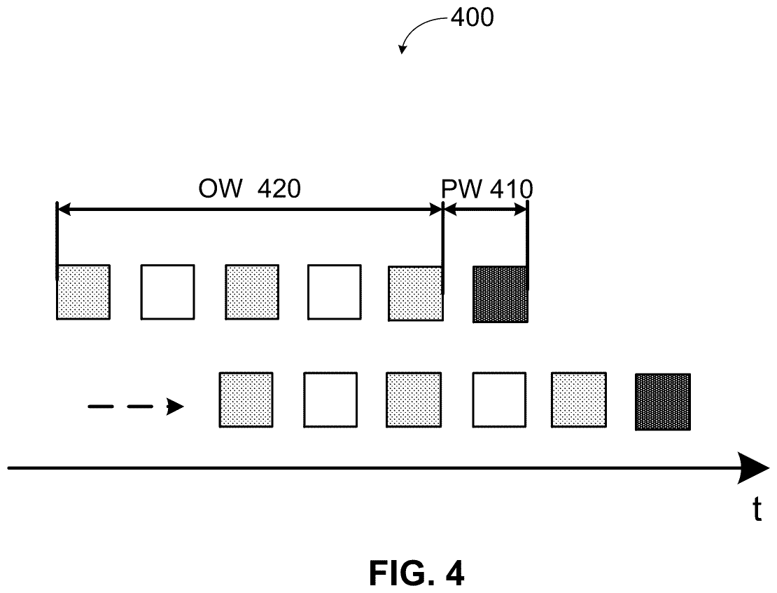

FIG. 3 and FIG. 4 depict example 1 and example 2 of intra-frequency temporal domain case B 300 and 400, respectively. In intra-frequency temporal domain case B 300, 400, measurement results in PW 310, 410 may be predicted by historical measurement result(s) in OW 320, 420. Then OW 320, 420 and/or PW 310, 410 slide forward with either sampling period(s) (e.g., with sliding L1/L3 filtering option) or measurement period(s) (e.g., with non-sliding L1/L3 filtering option) and/or measurement result(s) in previous PW may be skipped during window sliding.

Intra-frequency, intra-cell spatial domain prediction may be evaluated for the first study goal by measuring a subset of configured synchronization signature block (SSB) as input to the model. This subset of configured SSB as input to the model may be used to derive L3 filtered cell-level measurements for every time instance of the same cell. These measurements may be evaluated for frequency range 2 (FR2) intra-frequency scenario. These frequencies may apply for RRM sub-use cases 1 and/or 3.

For both intra-frequency prediction inter-cell prediction and FR1 to FR1 inter-frequency inter-cell prediction, no measurement may be reduced in both temporal and spatial domain to measure a cell. For FR1 to FR1 inter-frequency inter-cell prediction, focus on the case on the cell to be measured and the cell to be predicted are in the same sector of either the serving site or same neighboring site. FR1 to FR1 inter-frequency inter-cell prediction may apply for all RRM sub-use cases.

Intra-frequency inter-cell prediction may refer to neighboring cell prediction based on measurements of either co-located and/or non-collocated serving cell and/or neighboring cell. The prioritization among evaluation scenarios in Rel-19 is shown below in table 1.

TABLE 1
depicts the prioritization of evaluation scenarios
for Rel-19 study on RRM measurement prediction.

| Scenario | | | Target | |
|---|---|---|---|---|
| number | Priority | Evaluation scenario | study goal | Methodology |
| 1 | Low | FR1 to FR1 intra-frequency temporal | 2^{nd} goal | TBD |
| | | domain case A | | |
| 2 | High | FR1 to FR1 intra-frequency temporal | 1^{st} goal | Intra-cell |
| | | domain case B | | |
| 3 | High | FR1 to FR1 inter-frequency (frequency | 1^{st} goal | Inter-cell |
| | | domain) | | |
| 4 | High | FR2 to FR2 intra-frequency temporal | 2^{nd} goal | Intra-cell |
| | | domain case A | | |
| 5 | Low | FR2 to FR2 intra-frequency temporal | 1^{st} goal | TBD |
| | | domain case B | | |
| 6 | Middle | FR2 to FR2 intra-frequency spatial | 1^{st} goal | Intra-cell |
| | | domain | | |

As a result of the above, the WTRU may report for a given cell and/or beam of that cell one of more of the following: the current measured RRM quantity and/or quantities; the predicted RRM quantity and/or quantities for the current time instance (e.g., in inter-cell and/or inter-frequency prediction cases); and/or the predicted RRM quantity and/or quantities for future time instances (e.g. in temporal prediction cases).

An important aspect in providing seamless and/or high-quality connectivity is managing the mobility of WTRUs, both in inter-radio access technology (RAT) and intra-RAT cases. Handover (HO) mechanisms may play a pivotal role in fulfilling that role in an efficient and non-intrusive to the WTRU manner. HO mechanisms may be based on a set of RRM measurements the WTRU performs at configured time intervals. HO mechanisms may be based on the WTRU's subsequent reporting of such measurements, either in a periodical way and/or upon fulfilment of certain events, such as the signal levels of a neighboring cell becoming larger than the signal levels of the current cell by a certain margin, etc. Upon receiving the measurements and/or events reports, the network may use them for efficiently managing and/or optimizing the network infrastructure and/or recourses (e.g., balancing the load across cells by handing over a certain number of WTRUs between them). Alternatively, to further improve the reliability and efficiency of the HO process, the network may configure the WTRU to initiate the HO process upon the fulfilment of certain conditions via the conditional HO (CHO) mechanism, without the WTRU having to wait network's decision about initiating an HO procedure.

Even when a WTRU performs a CHO, after initiating the HO process, the WTRU may inform the involved cells about the CHO. As such, RRM measurements and/or the subsequent reporting may provide the network with the necessary awareness and/or guidance to efficiently manage WTRU mobility. Such guidance may include, e.g., handing a WTRU over to the best candidate cell and assigning appropriate RACH recourses by identifying the best beam in the target cell, etc.

The network may configure a WTRU in RRC_CONNECTED state to perform RRM measurements for one or more cells and/or in one or more frequencies. The measurement configuration-related parameters may be contained in a MeasConfig IE that is provided to the WTRU upon establishing and/or resuming an RRC connection based on dedicated signaling (via RRCReconfiguration or RRCResume). Then, the WTRU may measure the configured parameters (e.g. RSRP at one or more cells and/or beams) and/or apply L3 filtering for both cell and/or beam measured quantities.

The measurement configuration the WTRU receives may also include a reporting configuration. This configuration may specify the reporting criterion (e.g., periodical and/or event-based reporting) based on which the WTRU may report the measured quantities. The configuration may also specify the type of reference signal (RS) the WTRU uses to perform its measurements on (e.g., synchronization signal physical broadcast channel (SS/PBCH) block or channel state information resource signal (CSI-RS)). Finally, the configuration may define a reporting format that includes the measured quantities and/or additional information, such as the maximum number of cells and/or beams per cell to report.

In legacy mobility, the network may base its mobility-driven decisions on a reactive approach via the current RRM measurements the WTRU reports. However, artificial intelligence machine learning (AIML) models that generate predictions for future time instances may allow the network for a more proactive decision-making approach. However, this benefit may come with new challenges that affect RRM measurement reporting.

In legacy RRM measurement reporting, a single value is reported for each measurement quantity (e.g., reference signal received power (RSRP), reference signal received quality (RSRQ), and/or signal to noise ratio (SINR) for a given cell and/or beam. That value may correspond to the current (e.g., time instance) value the WTRU measures for the concerned cell and/or beam according to the received measurement configuration. In contrast, when an AIML model is used to generate RRM predictions in the temporal domain, the WTRU may have available multiple values to report for each measurement quantity for a cell and/or beam. These values may correspond to predicted quantities for future time instances. Even when the AIML model may generate RRM predictions for the current time instance (e.g., in frequency and/or temporal domain), such values may not be measured as in legacy RRM measurement framework. Rather, such measurements may be predicted.

Additionally, when the WTRU is configured with legacy RRM reporting, the WTRU may include measurements of a predefined number of the top-n (where n is configurable) neighbor cells for the current reporting time instance. The WTRU may also report, along with the L3 cell level measurements, the L3 measurements of the top-m beams (where m is also configurable). However, when a WTRU has both RRM measurements and predictions for various neighbor cells and/or beams for the current as well as for future time instances, it may be ambiguous how to determine the top neighbor cells (among the measured and predicted cells) to include in the measurement report. Further, determining which beams of those cells to include (among the measured and predicted beams) may also be ambiguous.

The reporting of multiple RRM measurement results for a given cell and/or list of beams in a cell may be performed in an efficient and/or concise way to reduce reporting overhead. This reporting may also differentiate between the different types of reported RRM measurement results (e.g., measured and/or predicted), so that the network can effectively monitor the accuracy of the AIML model and/or take the necessary steps if that accuracy worsens. Reporting multiple instances of RRM measurement predictions may lead to reporting overhead and/or may impact the network's efficiency if enhancements are not made to the current RRM reporting framework.

A WTRU may perform AI/ML based RRM measurement prediction and/or report the corresponding measurements and/or predictions for a given cell and/or set of beams in the cell. The WTRU may be configured with thresholds and/or conditions (e.g., that are related to current measurements and/or predicted measurements), according to which it decides how often the reporting is performed, whether to include RRM measurements, predictions, or both in the measurement report, how many time instances of measurements and/or predictions are included for each cell, and in what form such measurements and/or predictions are included (e.g. detailed vs. summarized information). After performing the configured RRM measurements and/or predictions, the WTRU may send RRM measurement reports whose content and/or periodicity may be controlled by the configured thresholds and/or conditions.

The WTRU may receive an RRM measurement configuration containing the following: one or more configurations for performing RRM measurements and/or RRM measurement predictions for one or more cells and/or/beams at one or more frequencies, together with additional prediction-related parameters (e.g., MRRT, measurement skipping pattern, OW lengths, and/or PW lengths, etc.).

The WTRU may further receive one or more reporting configurations controlling: when measurement reporting takes place by specifying the type of reporting (e.g., periodical or event-based); reporting periodicities for each reporting type; and/or measurement and/or prediction thresholds of the serving cell (e.g., RSRP value, RSRP difference) for periodical reporting. The reporting configurations may control how many cells and/or beams per cell to report by specifying: the maximum number of predicted and/or measured cells to report, and/or the maximum number of predicted and/or measured beams per cell to report. The reporting configurations may control the maximum number of time instances, for which to report measured and/or predicted RRM measurements for each cell, based on the ranking of each cell (e.g. based on the cell qualities of each of the top-n cells). The reporting configurations may include the reporting content for each cell and/or beam by specifying thresholds (e.g., RSRP difference) that control whether and/or how measured and/or predicted RRM measurements are reported. The measurement and/or prediction may be reported according to: a forward-looking approach, where predictions are compared among themselves and/or with the current measurement; and/or a backward-looking approach, where the current measured or predicted RRM measurement is compared to previously reported predicted or measured RRM measurements

The WTRU may perform RRM measurements and/or RRM measurement predictions for the configured cells and/or beams at the configured frequencies. The WTRU may determine the reporting periodicity and/or offset of one or more predicted and/or measured RRM measurements for one or more cells based on current serving cell measurements (e.g., cell signal level) and/or configured thresholds. The WTRU may report the determined reporting periodicity and/or offset.

The WTRU may report at least one predicted and/or measured RRM measurement based on the determined reporting periodicity and/or offset. The WTRU may determine the content of the report based on the following: the WTRU may determine the top-n best cells as a function of the current measured and/or predicted cell-level results. The WTRU may determine the top-m best beams for the selected top-n best cells as a function of the current measured and/or predicted beam-level results. For each cell and/or beam included in the report, the WTRU may determine, in sequence: the maximum number of time instances to be reported based on the ranking of each cell and/or beam; whether to include or skip the current measurement and/or predictions based on their statistical significance according to the configured thresholds (e.g. depending on the RSRSP difference between the current measurement and/or predictions and previously reported measurements and/or predictions); and/or whether to include or skip one, all, or a subset of the predictions within the PW, and/or summarized prediction results, based on the statistical variation of the predictions according to the configured thresholds and in accordance with the maximum number of allowed time instances.

The WTRU may send the measurement report including one or more of: the one or more included measured or predicted RRM measurements and/or an indication for the determined top-n cells and/or top-m beams where measurement reporting was skipped, the corresponding skipping cause.

Disclosed herein is the measurement and/or mobility framework in new radio (NR). In NR, when a WTRU is in RRC_CONNECTED state, the WTRU may measure the signal level of one or more beams of a cell and/or the measurement results are averaged to derive the cell quality. This may also be referred to as beam consolidation. This process may include the linear averaging of a maximum number of top beams that have a signal level above a certain threshold. Filtering may take place at two different levels: at the physical layer (L1) level, to derive beam quality, and at RRC (L3) level, to derive cell quality from multiple beams. Cell quality from beam measurements is derived in the same way for the serving cell(s) and for the non-serving cell(s). Measurement reports may contain the measurement results of the X best beams if the gNB configures the WTRU to do so.

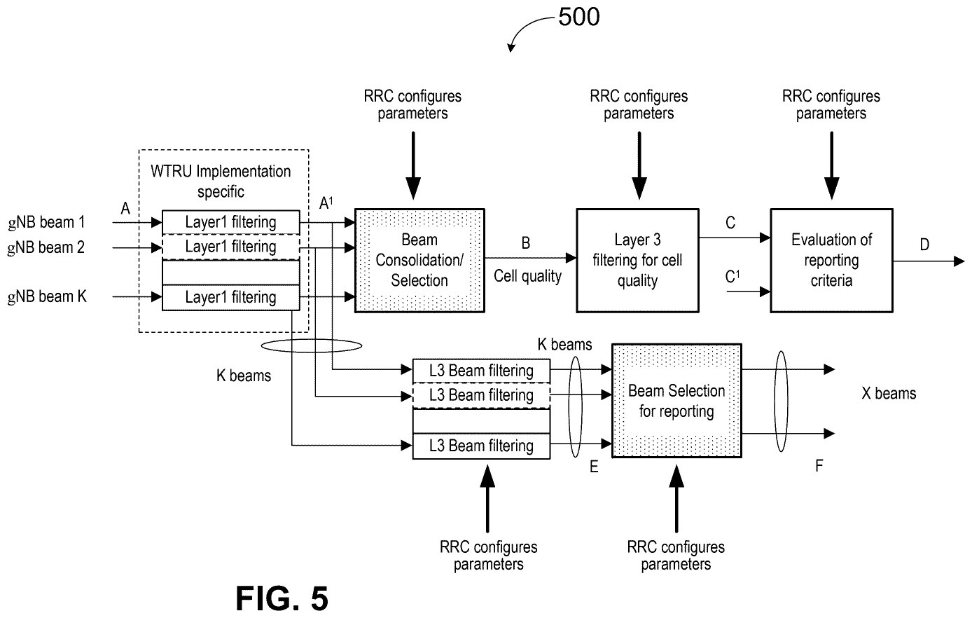

FIG. 5 depicts a corresponding high-level (NR) measurement model 500. A WTRU may perform measurements of serving cells and/or neighbor cells based on a configuration received by the gNB. The WTRU may report the measurements periodically or when certain events are fulfilled (e.g., A3 event, where a neighbor cell's signal quality becomes better than the serving cell by more than a certain threshold). Based on the measurement reports, the network may send a handover (HO) command to the WTRU indicating for the WTRU to switch the connection to the target cell indicated in the HO command. The network may send an HO command at any time (e.g., without receiving a measurement report) for switching the connection of the WTRU to another cell (e.g., for load balancing purposes).

The WTRU may be configured with a conditional handover (CHO) configuration, which contains an HO command and/or associated measurement event. When the measurement event conditions get fulfilled, the WTRU may execute the HO command associated with the event instead of sending a measurement report.

The existing RRM measurement configuration may comprise: measurement objects (what is to be measured, e.g., frequency, cells, SSB/CSI-RS config, offsets, and/or measured quantities, e.g., cell level measurement derivation parameters, etc.); reporting configurations (what is to be reported and/or when it is to be reported, e.g., periodicity, event thresholds, time to trigger (TTT), hysteresis, and/or CHO config, etc.); measurement IDs (association of a measurement object with a reporting configuration, e.g., if there is no measID associated with a measurement object, the WTRU may not perform the measurement according to the measurement object configuration).

The measurement configuration may be provided to the WTRU in an RRCReconfiguration message that may contain a MeasConfig IE. The MeasConfigIE may further contain several IEs to configure the measurement objects (e.g., a list of MeasObjectNR), reporting configurations (e.g., a list of reportConfigNR), a list of measurement identities that link the measurement objects with reporting configurations (e.g., a list of measId), and/or other relevant information for performing measurements, such as measurement gaps (for inter-frequency measurements), and/or the filtering coefficients to be applied, etc.

Artificial intelligence may be broadly defined as the behavior exhibited by machines. Such behavior may, for example, mimic cognitive functions to sense, reason, adapt, and/or act.

Machine learning may refer to the type of algorithms that solve a problem based on learning through experience (via data), without explicitly being programmed (via a fixed set of rules). Machine learning may be considered a subset of Al. Different machine learning paradigms may be envisioned based on the nature of data or feedback available to the learning algorithm. For example, a supervised learning approach may involve learning a function that maps an input to an output based on labeled training examples. Each training example may be a pair consisting of an input and the corresponding output. An unsupervised learning approach may involve detecting patterns in the data with no pre-existing labels. Finally, a reinforcement learning approach may involve performing a sequence of actions in an environment to maximize the cumulative reward. It may be possible to apply machine learning algorithms using a combination of the above-mentioned approaches. For example, a semi-supervised learning approach may use a small amount of labeled data together with a large amount of unlabeled data during training. In this regard, semi-supervised learning may fall between unsupervised learning (with no labeled training data) and supervised learning (with only labeled training data).

All the solutions described herein are agnostic to: the kind of AI/ML model and/or technique used by the WTRU (e.g., the AI/ML algorithm used, the AI/ML model's type (e.g., neural networks, decision trees etc.), the specific network structure (e.g., the depth of a neural network and/or other hyperparameters), the origins of the model (e.g., WTRU vendor, operator, and/or network vendor, etc.,), or how and/or where the training of the model is done (e.g., the input data used for the training, where the training is performed, if the training is performed offline or online, etc.). However, the model may be trained based on historical observations from one or more of WTRUs' actual measurements in different WTRU and/or network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training and/or collection of training data, etc.).

Although the descriptions below are mainly focused on RRM measurement prediction, all aspects may apply equally to other functionalities based on RRM measurement event prediction (e.g., indirect event prediction based on RRM measurement predictions and/or CHO based on predicted events, etc.). For example, when a measurement report is triggered due to the fulfillment of the conditions for the event (e.g., event A3), the WTRU may determine the contents of the measurement report based on the solutions described herein.

The solutions related to modifying the reporting periodicity based on thresholds related to the serving cell signal level may also apply to event-based reporting (e.g., controlling the periodicity of subsequent measurement report that is periodically triggered due to the fulfillment of the event conditions).

Though the solution descriptions below focus on prediction based on AI/ML models, the proposed solutions may equally apply to any other form of prediction that doesn't use AI/ML (e.g. time series forecasting, interpolation methods, etc.).

As used throughout this disclosure, the terms “AI/ML” and “AIML” may be used interchangeably. The terms “data”, “report” and “results” may be used interchangeably. The term “RRM measurement result(s)” is used to refer to any combination of RRM-based collected data, e.g., RRM measurements, RRM measurement predictions and/or both. The terms “RRM measurement prediction(s)” and “RMM prediction(s)” are used interchangeably. The terms “support” and “capability” may be used interchangeably (e.g., a WTRU indicates that it supports XYZ, and a WTRU indicates that it is capable of XYZ, etc.). The terms “indication”, “information” and “message” may be used interchangeably. The terms “summarized”, and “aggregate” may be used interchangeably. The terms “current cell,” “serving cell”, and “source cell” may be used interchangeably. The terms “target cell,” “candidate cell,” and “neighbor and/or neighboring cell”, may be used interchangeably. The terms “handover” and “cell switching” may be used interchangeably. The terms “functionality” and/or “procedure” may be used interchangeably. The terms “execute,” “apply,” and/or “perform” may be used interchangeably. The terms “legacy” and “non-AIML” may be used interchangeably. The terms “prediction” and “estimation” may be used interchangeably. The terms “configuration” and “functionality” may be used interchangeably. The terms “(sub) use case” may be used interchangeably with “(sub) functionality”. The terms “information element (IE)” and “parameter” may be used interchangeably. The term “AIML mobility” may be used to collectively refer to the different use cases and/or functionalities that are related to mobility, and which are enhanced via AIML based prediction (e.g., AIML based RRM measurement prediction, measurement event prediction, handover failure prediction, and/or radio link failure prediction, etc.). The terms “measurements” and “signal levels” may be used interchangeably (e.g., predicted cell and/or beam signal levels and predicted cell and/or beam measurements, etc.,)

In some of the descriptions below (for example, temporal predictions where the WTRU is doing the actual measurements as well as future predictions of a given cell and/or beam), the term performing the measurement according to the measurement prediction configuration may be used interchangeably to refer to both the measurement and prediction aspects.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (forward slash) may be used herein to represent ‘and/or’, where for example, ‘A/B’ may imply ‘A and/or B’. The phrases “maximum time instances to report” and “reporting window” may be used interchangeably. The phrase “number of time instances to report” may refer to the number of RRM measurement results (measurements and/or predictions) that may be reported for a given cell and/or beam in a measurement report. The length of a given time window (e.g., OW, PW, reporting window) may be defined in the current document, without any loss of generality, in terms of the number of time instances within the window. The length of a given time window may be defined as a (absolute and/or relative) time duration (e.g., 40 ms).

The WTRU may have access to L3 filtered results (e.g., cell and/or beam). Thus, the current document does not consider how the WTRU filters the collected L1 results as it pertains to each of the different sub-use cases described above and herein.

A given AIML model may be trained under certain WTRU and/or network side additional conditions. For example, a WTRU side condition could be the speed of the WTRU. On the other hand, network side additional conditions may relate to network configurations and/or settings that the WTRU may not be aware of but may impact the performance of the model. For example, a beam/cell level measurement prediction model may perform differently if trained while the network uses a certain antenna pattern, antenna height, beam pattern, and/or base station transmission power levels, etc. Also, there may be aspects related to network load that may impact on the model performance (e.g., the model predicts radio link failure which depends on the level of interference).

In the solution descriptions discussed below and herein, it is assumed that under normal conditions, the WTRU will perform the AIML based operations if the WTRU has an AIML model that applies to the current WTRU and/or network side additional conditions (or at least a model tested to perform well enough for the current WTRU and/or network side additional conditions). In other words, the WTRU may support AIML inference requests regarding a mobility functionality. The WTRU may have never received an inference configuration tailored to the WTRU's capabilities for AIML inference for a given AIML mobility-based functionality and that such a functionality is activated. Herein, that functionality is RRM measurement prediction. RRM measurement precision may involve all sub-use cases listed in Table 1. Moreover, it is assumed that the applicability of the activated functionality is not expected to change for the duration concerned within the solutions provided.

In general, the AIML model may be stored in the WTRU, or stored on the network side. For the solutions provided below and herein, it is assumed that a WTRU-side AIML model exists. If a network-side model exists, the reporting of the WTRU will be similar to legacy reporting, as the WTRU does not have access to any RRM predictions to report.

A different reporting configuration may be provided to those cells and/or beams per cell where RRM predictions are generated. A different reporting configuration may be provided to those cells and/or beams per cell where measurements may be collected. In that case, a new ReportConfigNR may be defined, containing IEs related only to predicted RRM measurement results, while the existing ReportConfigNR may be used for RRM measurements reporting, as in legacy.

The same reporting configuration may be provided, regardless of the type of requested RRM measurement result (measured and/or predicted). In such a case, the differences in the standards between measured and/or predicted results, if any, may be handled within the same configuration, e.g., by defining new IEs and/or modifying existing ones to also consider RRM predictions. The reporting configuration provided to the WTRU may specify when reporting occurs. Such reporting may be either periodical or event-based reporting.

The WTRU may report RRM measurement results (measured and/or predicted) in a periodical and/or event-based way (as in legacy), controlled by configured reporting parameters such as the periodicity of the reporting, the total amount of reports to be sent, and/or whether the configured triggering conditions for (legacy) event-based reporting are satisfied.

Within a reporting configuration, different reporting periodicities may be configured depending on whether the reported RRM measurement results are measured and/or predicted. This may be specified on a reporting configuration level. For example, a reporting periodicity of T1 may be configured for those cells where only measurements are performed, whereas a reporting periodicity of T2 may be configured for those cells where only predictions are generated. In this example, T2 may be configured to be shorter than T1 to allow more frequent monitoring and/or reporting of the WTRU and of the accuracy of its predictions. In another example, T2 may be configured to be longer than T1, if predicted measurements do not change significantly over time. Similarly, a reporting periodicity of T3 (e.g., T1<T3<T2), may be configured for those cells where both measurements and/or predictions are to take place (e.g., temporal predictions).

The same reporting periodicity may be used for all cells and/or beams configured with a reporting configuration regardless of whether predictions and/or measurements take place for these cells and/or beams.

Different reporting periodicities may depend on whether the reported RRM measurement results are measured and/or predicted on a cell and cell and/or beam level. For example, a reporting periodicity of T1 may be configured for the top cell within the measurement object associated with the reporting configurations, and another reporting periodicity T2 may be configured for the remaining top-n cells, where T1<T2.

A single (e.g., default) reporting periodicity may be configured within the reporting configuration. A list of reporting periodicities may be configured, instead of, or along with the default reporting periodicity. For example, a reporting configuration may contain a list of reporting periodicities [T₁, T₂, . . . , T_{N}], and/or a list of maximum numbers of reports to be sent [Nr₁, Nr₂, . . . , Nr_{N}]. Then, the WTRU may select which reporting periodicity and/or maximum number of reports to choose from the corresponding lists, based on the configured thresholds for selecting these parameters, the current signal levels of the serving cell, and/or other conditions.

All solutions and/or disclosures made herein that describe how reporting periodicity may be configured may equally apply for determining the reporting offset and/or the maximum number of reports the WTRU may send.

The following thresholds may be configured for helping and/or instructing the WTRU on how to determine its reporting periodicity: thresholds pertaining to the WTRU speed; thresholds pertaining to the WTRU location; thresholds pertaining to RRM measurements (e.g., RSRP levels, and/or relative change of RSRP level over a given time, etc.); thresholds pertaining to predicted RRM measurements (e.g., predicted RSRP levels, and/or relative change of predicted RSRP levels within a given time, etc.); thresholds pertaining to differences between measured and/or predicted values (e.g., RSRP levels); and/or thresholds pertaining to the accuracy of RRM predictions. These thresholds may be: absolute thresholds (e.g., absolute WTRU speed and/or RSRP levels, etc.); relative thresholds (e.g., WTRU speed and/or RSRP absolute and/or percentage difference, and/or compared to default values, etc.). How the WTRU uses these thresholds to determine the reporting periodicity is discussed below and herein.

In the current standards specification, the maximum number of cells for which reporting may be enabled in a reporting configuration is 8. In one solution, the same number of maximum cells is used, now involving cells where both RRM measurements and/or RRM predictions may take place. In another solution, three such maximum limits may be specified: one for cells where only measurements are collected (as in legacy), another for cells where only predictions are generated, and a third for cells where both measurements and predictions take place. In another solution, two such maximum limits may be specified: one for cells where only measurements are collected and another for cells where predictions (and possibly measurements) are performed. In another solution, two such maximum limits may be specified: one for cells where only predictions are collected and another for cells where measurements (and possibly also predictions) are performed.

A similar scheme may be devised for the maximum number of beams to be reported per cell. That number is currently set to 32 in the standards specification. The number may be differentiated between the maximum number of measured beams to be reported, an equivalent number for beams to be predicted, and/or another number for beams for which both predictions and/or measurements take place.

A single value may be used for the maximum number of cells to report (and another for the beams per cell), without further indication of maximum number of cells and/or beams per cell to report per RRM measurement result type (measurements and/or predictions). The WTRU may determine how many of them should belong to measured cells and/or how many to predicted cells based on a configured condition. The WTRU may not differentiate between measured and/or predicted cells. The WTRU may just report the top-n measured and/or predicted cells. The WTRU may include the predicted cells if they are better than the measured cells by more than a certain configured threshold. The WTRU may include the predicted cells if the measured cells are below a certain configured absolute and/or relative threshold, e.g., more priority given to include measured cells than predicted cells, etc. In another solution, the WTRU may select what cells and/or beams per cell to include in the report.

If more than one value is used for each of the maximum numbers of cells and beams to report, then these values may be updated dynamically over time based on monitoring key performance indicators (KPIs) and/or applicability changes of the activated AIML functionality. For example, the network may initially decide to have equal values for the maximum allowed reporting numbers between cells and/or beams to be measured and cells and/or beams to be predicted. Then, due to a deteriorating prediction accuracy of RRM measurements, the network may reconfigure the WTRU to report a higher proportion of cells and/or beams to measure compared to those to predict. Similarly, after an applicability change of the activated functionality of RRM measurement prediction (e.g., due to a WTRU speed change) that may lead to that functionality becoming non-applicable for some (or all) of the configured cells, the proportion of measured to predicted cells and/or beams per cell may also increase.

A reporting configuration may allow the WTRU to report the RRM measurement result of the best non-serving cell (reportAddNeighMeas) for a given frequency. However, both predicted and/or measured values may be available for cells operating at the frequency. In one solution, the WTRU may include in the report the best neighbor at that frequency, regardless of whether the determination quantity (e.g., RSRP and/or RSRQ) is measured and/or predicted. In another solution, the WTRU may report the two best neighbors: one determined among the measured cells, and another determined among the predicted cells (e.g., if RRM predictions take place for at least a certain number of the configured cells). In the case of temporal predictions, the WTRU may report as the best non-serving cell the cell that has the best radio conditions both in terms of actual measurements and in terms of predicted measurements (e.g., the WTRU uses the averaged filtered value of the current and predicted measurements of each cell to determine the best cell). In another solution, if the best non-serving cell based on actual measurements is different from the best non-serving cell based on predictions, the WTRU may report the best cell based on actual measurements or the best cell based on predicted measurements, or report both cells.

The WTRU may be configured with a maximum number of time instances for which measurements and/or predictions are to be included in the measurement report (e.g., per cell results, per beam results, etc.). This, for example, may be specified on the measurement object configuration level, measurement reporting configuration level, and/or measurement ID configuration level. For each of the cells and/or beams within the cell included in the measurement report, the WTRU may include the same number of RRM measurements and/or predictions (e.g., N). In another example, two maximum numbers of RRM measurements and/or predictions may be specified in the reporting configuration, one for cells (N1) and one for beams (N2). Then, the WTRU may be configured with N1, which is the maximum cell level RRM measurements and/or predictions to include for each of the cells included in the report. The WTRU may be configured with N2, which is the maximum number of beam level RRM measurements and/or predictions to include for each beam of the cell included in the measurement report.

The maximum number of predictions N may be specified on the cell level. In such a case, the WTRU may be configured with a variable number of maximum RRM measurements and/or predictions to report for each cell, e.g. the WTRU may report up to 2 RRM measurements and/or predictions for cell A, up to 3 RRM measurements and/or predictions for cell B, and so on. Then, the maximum number of RRM measurements and/or predictions for the best beams of each cell shall equal the numbers configured for the respective cells. For example, the WTRU may report up to two RRM measurements and/or predictions for the top beams for cell A of the previous example.

The maximum number of time instances (e.g., that equals the maximum number of RRM measurements and/or predictions to report) may be specified both on the cell and/or beam level. In such a case, the WTRU may be configured with a variable number of maximum time instances to report for each of the cells and/or beams within a cell. For example, the WTRU may be configured with up to 2 time instances for cell A and with up to 4 time instances for that cell's corresponding beams. The WTRU may also be configured with up to 3 time instances for cell B and/or with up to 6 time instances for that cell's corresponding top beams.

Single values for the maximum number of time instances corresponding to each cell and/or beam may be configured, as what was described before. For example, the network may configure a maximum number of 2 time instances for the top cell, and a maximum number of 3 time instances for the best beam of that cell.

A list of values may be configured for the maximum number of time instances corresponding to each cell and/or beam. For example, the WTRU may be configured for the top cell with a list of [2, 3, 4] maximum time instances and/or for the top beam of that cell with a list of [3, 4, 5] maximum time instances. Then, the WTRU may decide what value to use for its reporting based on the accuracy of its predictions, the availability of results to report (measured and/or predicted), the length of its PW, and/or the statistical significance of the results to be reported, etc.

The concept of maximum time instances to report may equate to a reporting window. The size of the reporting window (e.g., the maximum number of time instances to report), either in the time invariant or time-varying case, may be based on the length of the PW that the WTRU may support. If these two windows are equal (or the reporting window is larger by 1 time instance than the PW), then the WTRU may be able to report all its RRM predictions in addition to any current measurements.

The size of the reporting window may also be dictated by network capacity considerations (e.g., controlling the amount of reporting during periods of traffic load in the network) and/or by WTRU efficiency considerations (e.g., preserving as much battery as possible when a WTRU exhibits low battery levels). In both cases, the WTRU may be configured with a reporting window smaller than what the WTRU may support.

The WTRU may report RRM measurement results for specific time instances. For example, the WTRU may always report, for example, the first RRM prediction, the last RRM prediction, or the first two RRM predictions within its reporting window. The WTRU may make these reports assuming that these RRM predictions satisfy the configured thresholds pertaining to the accuracy and/or statistical significance of the RRM predictions. In another example, the WTRU may report specific time instances that satisfy additional conditions, such as the largest and/or smallest RRM prediction within the reporting window.

Similarly, the WTRU may report summarized and/or detailed information regarding the RRM prediction. The WTRU may report individual RRM measurement results up to the length of the reporting window. The WTRU may summarize its predictions by, e.g., reporting only the average within the PW and/or reporting window, the median of the RRM predictions and/or (optionally) additional statistical parameters such as the standard deviation and/or variance of the RRM predictions within the PW and/or reporting window, etc.

The WTRU may be configured with a combination of the above methods. For example, the WTRU may always report the first x RRM predictions and/or summarize the remaining ones (e.g., up to the maximum size of the reporting window).

In cases where the configured reporting window is smaller than the PW, the number of time instances the WTRU may report shall not exceed the configured reporting window.

To evaluate the statistical variation of the current RRM measurement and/or RRM predictions compared to previously reported RRM measurement results (measured and/or predicted), new thresholds may be defined.

In the “backward-looking” approach, the statistical significance of an RRM measurement and/or prediction of a given time instance may be evaluated by comparing it to previously reported RRM measurement and/or prediction for the same and/or prior time instances. In the “forward-looking” approach, the statistical significance of an RRM measurement and/or prediction of a given time instance may be evaluated by comparing it to prediction for future time instances.

The configured thresholds may associate two RRM measurement results (e.g., current and last reported RRM measurement) based on one or more of the following: their relative and/or absolute difference; their relative and/or absolute percentage difference; their relative squared (or higher order) difference; and/or their correlation coefficient, etc.

Additional thresholds may associate multiple RRM measurement results (e.g., current and/or last n reported measured values, and/or current measured and/or n predicted values) based on one or more of the following: the range (max_value−min_value) among the measured and/or predicted values (e.g., the n+1 values); the average (weighted or non-weighted) or median of the measured and predicted values; the standard deviation and/or the variance (or other similar second order statistics) of the measurements and/or predictions; statistics derived from the rate of change of consecutive measurements and/or predictions (e.g., results following a consistent increasing or decreasing trend); and/or statistics derived from higher order moments (e.g., third order moments or higher, such as skewness, and/or kurtosis, etc.), etc.

The same threshold values may be configured in both the forward-looking and the backward-looking approach. In another solution, different thresholds may be configured in each of the approaches. For example, a different threshold may be defined when comparing the current measurement to prior reported measurements and/or predictions, and a different threshold may be defined when comparing that same measurement with predictions for future time instances.

Similarly, in one solution, the same threshold values may be configured for both measured and/or predicted RRM measurement results, e.g., each configured threshold may be used for both measured and/or predicted results. Different threshold values may be defined for each one of them, e.g., two thresholds may be defined for each of the threshold types configured. Finally, a third threshold value may be defined when both RRM predictions and/or measurements are performed for the same cell and/or set of beams in a cell over time. For example, the network may configure an absolute RSRP difference threshold of 0.5 dB when evaluating the statistical significance of the current measurement compared to the previously reported measurement. The network may configure another absolute RSRP threshold of 1 dB when evaluating the statistical significance of an RRM prediction to the current measurement. The network may configure another RSRP threshold of 1.5 dB when evaluating the statistical significance of an RRM prediction compared to other such RRM predictions for other time instances (e.g., in cases where multiple predictions are available). Regarding temporal domain case A, one threshold may be configured when comparing the current measurement to the previously generated prediction for the same time instance during the backward-looking approach, and a different threshold may be configured when comparing the predictions between themselves during the forward-looking approach.

Note that when comparing two RRM values, these need not correspond to two distinct time instances (e.g. current and/or previously reported RRM measurement). They may also correspond to aggregate RMM results. Such results may include the current RRM measurement and/or predicted mean over the reporting window, or current RRM measurement and a mean of the K previous RRM measurements that were reported, etc. Similarly, for configured thresholds that associate more than two values, these values may correspond to the n previously reported RRM predictions and/or measurements, the m current predictions (for a total of n+m values), the n previously reported RRM predictions and/or measurements, the current aggregate prediction (for a total of n+1 predicted values), and/or any other combination thereof that may involve both aggregate and non-aggregate results.

The thresholds may be the same for all configured time instances. For example, a threshold for an RSRP difference of 2 dB may be specified for all time instances within the reporting window.

The thresholds may be a function of the specific time instance to be reported. Stricter thresholds may be defined for time instances closer to the current reporting time, while more lenient thresholds may be defined for more distant time instances. For example, an RSRP difference of 1 dB may be configured for the first 2 time instances, an RSRP difference of 2 dB may be configured for the next 2 time instances, and/or an RSRP difference of 3 dB may be configured for the last 2 time instances (assuming that the maximum number of time instances to be reported is 6).

The same configured thresholds (time-varying or not) may be configured for each of the cell and/or beams to be included in the report. For example, the same time varying thresholds may be configured for all the top-n cells and/or top-m beams to be reported. The same time varying thresholds may be configured for all the top-n cells. Other time varying thresholds may be configured for all the top-m beams.

Different configured thresholds (time-varying or not) may be configured on a cell or on a cell and/or beam level. For example, different time varying thresholds may be configured for the top-2 cells, and/or different time varying thresholds may be configured for the remaining cells (up to the maximum top-n cells that can be reported). Time-invariant thresholds may be configured for different cells and/or beams as a function of the number of time instances configured for each of them. For example, an RSRP difference threshold of 1 dB may be specified for a cell where the maximum number of time instances to be reported is 3, and/or an RSRP difference threshold of 2 dB may be specified for another cell where the maximum number of time instances is 5 to offset the prospective of worsening prediction accuracy for later time instances.

Upon reception of a reporting configuration, the WTRU may perform the following: if serving cell thresholds for different reporting periodicities are configured, the WTRU determines the reporting periodicity.

When a measurement report is to be sent, the WTRU determines: the top-n best cells and, optionally, the top-m best beams for each of the selected top-n cells to report; the maximum number of time instances to be reported for each cell and/or beam within the top-n cells and/or top-m beams; whether to include in the report the current RRM measurement and/or predictions for each selected cell and/or beam based on their statistical significance; in what format (e.g., summarized vs. detailed) to report each of the available RRM measurement results for the selected cells and/or beams.

The WTRU may send the measurement report, along with indications if measurement reporting was skipped for some of the top-n cells and/or top-m beams, and, if so, additional indications for the cause. The actions described above and herein are described in more detail below. Note that such actions may be based on the reporting configuration the WTRU has received from the network.

The WTRU may be configured with a default reporting periodicity T1. In addition, the WTRU may be configured with a list of possible reporting periodicities (T1, T2, and/or T3, etc.). In the presence of some triggering conditions, the WTRU may choose a different reporting periodicity from the default periodicity T1.

A change in WTRU speed (e.g., derived from speed measurement tracking or RSRP or CSI changing levels) may trigger the WTRU to indicate a change in reporting periodicity from a current reporting periodicity configuration T1 to an updated frequency configuration T2. For example, as WTRU speed increases, RRM measurements may change more dynamically, requiring more frequent reporting with shorter periodicity (T2<T1). Similarly, when WTRU speed decreases, RRM measurement changes may be minor and less important to report. This may motivate the WTRU to report with a longer periodicity (T2>T1).

The WTRU may indicate a change in RRM measurement reporting periodicity due to a change of WTRU's location or serving cell. As the WTRU moves to a new location (e.g., determined by GPS or based on the serving cell), channel characteristics in the new location may differ from the previous location. For example, the new environment may be a denser urban environment with a high density of vehicle traffic, making it a more dynamic fast-varying environment when it comes to changes in channel state and RRM measurements. This may necessitate a shorter periodicity (T2<T1) for RRM measurement reporting. However, when the WTRU moves to a slowly varying environment, RRM measurements may need to be reported less frequently, with a longer periodicity (T2>T1).

Changing RRM reporting periodicity may be motivated by comparing absolute RRM measurements (e.g., RSRP) to certain thresholds. When the measured and/or predicted RSRP of a given cell becomes lower than a configured minimum threshold, there is a very minor probability for the given cell to be considered as a potential HO candidate. Therefore, reporting its measurements may be less frequent via a longer RRM measurement reporting periodicity. In another example, for any given cell(s) with absolute RRM measurements exceeding a certain threshold, The WTRU may indicate more frequent reporting via a shorter periodicity.

Comparing the difference between RRM measurements of the same cell or between multiple cells to certain thresholds may trigger and/or indicate a change in RRM measurement reporting periodicity. Differences between measurements may increase beyond a threshold and therefore be an indication of change in channel state and/or RRM measurements that require more frequent monitoring and/or inference, thereby needing reporting with a shorter periodicity (T2<T1). However, if the differences between RRM measurements are minor, the WTRU may choose to maintain the same periodicity or may switch to an even longer one (T2>=T1).

The WTRU may decide to modify its reporting periodicity (for its RRM predictions), as a function of the accuracy of its prediction over time. For example, the WTRU may select a shorter periodicity if the accuracy of its RRM predictions was high over a given period (e.g., due to having an accurate AIML model for the current WTRU and/or NW-side additional conditions). In another example, the WTRU may select a longer periodicity if the accuracy of its predictions over a given period has been steadily decreasing.

The triggering conditions for changing the reporting periodicity may remain persistent for a minimum period of time according to the condition (e.g., the metric and/or the threshold that this metric is compared against) before the WTRU may indicate a change in the RRM measurement reporting periodicity. This is done to avoid an excessive number of periodicity changes.

Further, the WTRU may consider a combination of two or more criteria from the aforementioned solutions to determine its reporting periodicity. For example, different criteria may be assigned equal weights. Hence, if criterion 1 suggests that a WTRU may use a shorter periodicity (T2<T1), and criterion 2 suggests that WTRU may use a longer periodicity (T3>T1), the WTRU may decide to not change its reporting periodicity. In another example, different criteria may be assigned different weights. Hence, if criterion 1 has a higher weight than criterion 2, the WTRU may use a shorter periodicity T4, such that T2<T4<T1. In a third example, an order of precedence for some criterion over the others may be used. Hence, if criterion 1 has higher order of precedence than criterion 2, the WTRU may use a shorter periodicity T2, as recommended by criterion 1.

The WTRU may decide on what cells and/or beams per cell to report based on the maximum allowed number of cells and/or beams per cell that has been configured; the availability of RRM measurement results (measured and/or predicted) for these cells and/or beams per cell for the current and/or future time instances; the configured number of maximum time instances to report per cell and/or beam; as well as any threshold control the statistical significance of such results.

The WTRU may be configured with a single value for the maximum number of cells and/or beams per cell to report. The WTRU may decide to report the best cells and/or beams per cell regardless of whether these cells and/or beams per cell have been configured for RMM measurements or predictions. Alternatively, the WTRU may decide to use a specific proportion of measured to predicted cells and/or beams and report the best cells and/or beams within these two groups up to the maximum allowed number of cells and/or beams per cell to report. The WTRU's implementation may determine how the proportion of measured to predicted cells and/or beams per cell is configured. The proportion of measured to predicted cells may depend, e.g., on availability of measured and/or predicted data at the WTRU and/or other factors, such as KPIs regarding the accuracy of its RRM predictions etc.

The WTRU may be configured with two separate values for the maximum number of cells and/or beams per cell to report: one value for the measured cells and/or beams per cell, and another for the predicted cells and/or beams per cell. In such a case, the WTRU shall report the best cells and/or beams per cell for each of the measured and/or predicted cells and/or beams per cell, while respecting the respective configured maximum allowed numbers for these two groups.

The WTRU may be configured with two separate maximum allowed numbers for cells and/or beams per cell to report (e.g., one for measurements and the other for predictions). The WTRU may also be configured with a third number indicating the maximum allowed total number of cells and/or beams per cell to report. In that case, the first two numbers may be interpreted as recommended maximum allowed numbers for measured and predicted cells and/or beams to report. Thus, the WTRU may try to not exceed the two configured thresholds. The WTRU may exceed the two configured thresholds in cases where the number of best cells and/or beams per cell of one group significantly surpasses the respective number of the other group. This may give the WTRU freedom to “trade space” between the two configured thresholds, if the WTRU deems appropriate, while still respecting the maximum allowed number (third threshold).

What cells and/or beams per cell the WTRU reports, apart from the maximum allowed numbers of cells and/or beams per cell to report, may be dependent on how the WTRU evaluates which cells and/or beams per cell are the best among the configured ones.

The WTRU may report the best cells and/or beams per cell, regardless of whether these cells and/or beams have been configured for RMM measurements and/or predictions, based only on the current time instance (while respecting the configured thresholds). In such a case, the WTRU may need to retain previous predictions for cells and/or beams per cell that pertain to the current instance if the WTRU does not expect to measure them.

The WTRU may report the best cells and/or beams per cell for the current time instance, as described above, but may report the best cells and/or beams per cell for future time instances within the reporting time window.

The WTRU may report the best cells and/or beams per cell for each of the future time instances within the reporting window. However, in another solution, the WTRU may report the best cells and/or beams per cell based on aggregate metrics over the duration of the reporting window. For example, for the first case, the measurement report may look like the following:
[Results_best_cells_t0, Results_best_cells_t1, . . . , Results_best_cells_tN]
   and for the second case, it may look like:
[Results_best_cells_t0, Results_best_cells_t1:tN]

For the first case, the WTRU may report the best cells and/or beams per cell for each of the future time instances based on the RRM predictions of the corresponding time instance. In another solution, the WTRU may determine what the best cell and/or beam(s) per cell is based on the given future time instance as well as other previous time instances (e.g. by using a moving average). In such a case, the measured value for the current time instance may also be used, if available. The number of reported time instances may be upper bounded by the configured reporting window.

For the second case, the WTRU may select the best cells and/or beams per cell over all time instances based on one or more of the following aggregate statistical metrics: central tendency statistical parameters, such as the arithmetic mean of the predicted values within the reporting window, the weighted arithmetic mean of the same predicted values, and/or the midrange of the predicted values within the same reporting window, etc.; dispersion statistical parameters, such as the standard deviation and variance of the predicted values within the reporting window, and/or the range of the same predicted values, etc.; and/or confidence intervals that may be provided by the AI/ML model for the predicted values for each of the future time instances within the reporting window.

When weighted statistics are used (e.g., the weighted mean of previous and/or future RRM predictions), the weights may be assigned based on how recent the corresponding RRM measurement results are, compared to the current reporting time. For example, recent time instances may be weighted higher than more distant time instances. Similarly, the weights may also be controlled by the relative importance of the configured thresholds for each of the time instances within the reporting window. For example, if the RSRP difference threshold for the first time instance is half compared to the second time instance, then the weight for the first time instance may be double the one of the second time instance, when computing a moving average over the predictions within the PW. The weights may also be influenced by the confidence intervals of the RRM predictions of the AIML model for specific time instances.

The WTRU may report the best cells and/or beams over all time instances, based on both the measurements and/or predictions for the current time instance as well as the predictions for future time instances. In such a case, similar aggregate metrics as the ones described above may be used, but now also considering the RRM measurement results for the current time instance. The results for the current time instance may be weighted more, compared to the ones in the future (e.g., by using a weighted average). The current RRM measurement results may be treated equally to any of the RRM measurement results for future time instances.

The WTRU may respect the configured reporting window and/or should not report RRM measurement results for more time instances than allowed. However, for computing aggregate metrics, since a single value (e.g., the aggregate metric) may be reported, the number of time instances included into the computation may be allowed to exceed the configured number.

When considering future predictions, either for reporting the best cells and/or beams per cell or for the computation of aggregate metrics, the number of predicted time instances may not match between different cells and/or beams. For example, the WTRU may have different AI/ML models for different cells, that support different PWs. In such cases, the WTRU may be configured with a minimum number of future RRM predictions to consider. For example, assuming the WTRU has m future RRM predictions for cell A and n such predictions for cell B, with m<n, the WTRU may consider min (m, n) time instances, or a configured number k, where m<k<n, either for reporting the best cells and/or beams or for computing aggregate statistics.

The following describe details regarding the determination by the WTRU of the number of time instances for which RRM measurement results may be reported. Prior to sending an RRM measurement report, the WTRU may determine the number of time instances to report for each of the selected cells and/or beams that are included in the report. The WTRU may select the number of time instances to report for each selected cell and/or beam according to one or more of the following: the maximum configured number of time instances to report; the ranking of each of the cells and/or beams to be included in the report; the statistical significance of the current and/or future RRM measurement results that can be reported compared to previously reported and/or current RRM measurement results; and/or the accuracy of RRM predictions compared to the corresponding ground truth data.

The number of reported time instances may not exceed the configured maximum time instances that can be reported for either a cell and/or a beam within the report. The number of reported time instances may also consider any ranking-based configured limits for each cell and/or beam, as well as the determination of such ranking.

The number of reported time instances may consider the statistical significance of the current RRM measurement compared to previously reported RRM measurement results, and/or the accuracy of the corresponding RRM prediction, before deciding to report the current RRM measurement. For example, the WTRU may decide to skip the current RRM measurement for cell A (assumed to be within the top-n cells) if the RRM measurement is not statistically significant compared to previously reported RRM measurement results. In another example, the WTRU may decide to include the current RRM measurement for the same cell if a previously generated prediction for that time instance is not accurate, based on the configured accuracy thresholds.

The number of reported time instances may consider the statistical significance of currently available RRM predictions compared to the current RRM measurement and/or previously reported RRM measurements and/or predictions, and/or the accuracy of such RRM predictions based on prior evaluations. For example, the WTRU may decide to skip entirely any RRM predictions for a cell, even if that cell is in the top-n cells, if such RRM predictions are not accurate according to configured accuracy thresholds. In another example, the WTRU may send a single aggregate result, if the RRM predictions are statistically significant compared to previously reported RRM measurement results, but lacking in variation over the reporting window.

The determination of the statistical significance of such RRM measurement results is described herein. The evaluation of the accuracy of the AIML model's predictions may be performed for the current time instance and/or may involve past time instances (e.g., a moving average of the accuracy of the AIML model over a given window). The evaluation may also include accuracy thresholds similar to the ones described before (e.g., relative and/or absolute RSRP difference between predictions and the ground truth, standard deviation and/or variance of the accuracy of such predictions, confidence intervals, weighted and/or non-weighted metrics, etc.).

The WTRU may skip entirely the reporting of any RRM predictions, based on worsening KPI metrics. For example, if the RRM predictions exceed the configured (error) thresholds for a certain amount of time, the WTRU may report the available RRM measurements, if any, skipping entirely any reporting for RRM predictions.

In temporal domain case A, the WTRU may perform RRM measurements and/or predictions at every time instance, according to the configured periodicity. As such, at any given time instance, the WTRU may have access to both the corresponding RRM measurement, as well as the RRM prediction associated with the same time instance.

In temporal domain case A, the backward-looking approach may involve comparing the current RRM measurement (the closest in time to the current reporting time) with one or more of the following: the previously reported RRM measurement; the previously reported k RRM measurements; an aggregate RRM measurement (over a window of m previously reported RRM measurements; the RRM prediction associated with the time instance corresponding to the current RRM measurements; and/or the average (weighted and/or non-weighted) of the associated RRM prediction with previously reported RRM measurements (e.g., last reported or more).

The forward-looking approach may involve comparing the current RRM measurement with one or more of the following: with any of the predictions associated with future time instances (e.g., the first or the last); with an aggregate RRM prediction over a window of m future time instances (that may be smaller than the PW of the AIML model and/or the reporting window); and/or any combination thereof, e.g. with some individual predictions for the first k time instances, and/or with an aggregate result computed over the remaining time instances within the PW and/or reporting window.

By performing the above comparisons, in conjunction to the configured thresholds, the WTRU may determine the statistical significance of the current RRM measurement and/or the currently available RRM predictions. Upon determining that, the WTRU may proceed to select how many time instances to report and in what form (e.g., summarized and/or detailed).

As the WTRU measures each time instance, the WTRU may have access to the ground truth for any of the RRM predictions it generates. In such instance, the evaluation of the AIML model's predictions for that case may be straightforward according to the configured accuracy thresholds and/or KPIs.

In temporal domain case B, the WTRU may either perform RRM measurements and/or RRM predictions for a given time instance. As such, the WTRU may have access to either the RRM measurement for a certain time instance, or the associated RRM prediction, but not both (unless extra measurements are configured for monitoring purposes).

In temporal domain case B, the backward-looking approach may involve comparing the RRM measurement closest to the current reporting time with any one or more of the following: the previously reported RRM measurement; the previously reported k1 RRM measurements; an aggregate RRM measurement over a window of m1 previously reported RRM measurements; the previously reported RRM prediction; the previously reported k2 RRM predictions; an aggregate RRM prediction over a window of m2 previously reported RRM predictions; the previously reported k1+k2 RRM measurement results (measurements and/or predictions); an aggregate RRM measurement result over a window of m1+m2 previously reported RRM measurement results (measurements and/or predictions); an average (weighted and/or non-weighted) of aggregate RRM measurements and/or predictions; and/or any combination thereof.

In temporal domain case B, the forward-looking approach may involve comparing the RRM measurement closest to the current reporting time with any of the same components specified for temporal domain case A.

For evaluating the accuracy of the RRM predictions of the AIML model for that case, the WTRU may either collect additional RRM measurements at configured time instances where RRM predictions are to take place, or it may generate additional RRM predictions for time instances where RRM measurements are performed.

Disclosed herein are concepts related to the statistical significance evaluation for inter-cell RRM predictions in temporal and frequency domain. In frequency domain prediction, the WTRU may perform RRM measurements at one frequency and then generate RRM predictions for the same time instance at another frequency. As a result, the WTRU may have access to only RRM predictions for the inference frequency. The frequency domain prediction may also have a temporal component. In such instance, the WTRU may perform RRM measurements at one frequency and then generate RRM predictions for the same time instance and/or future time instances at another frequency.

If there is no temporal component, only the backward-looking approach is applicable to evaluate the statistical significance of the available RRM measurement results. For frequency domain prediction, the backward-looking approach may be configured to involve comparing the RRM prediction that is closest to the current reporting time with one or more of the following: the previously reported RRM prediction; the previously reported k RRM predictions; an aggregate RRM prediction over a window of m previously reported RRM predictions; and/or any combination thereof.

If there is a temporal component, the forward-looking approach may also apply. In such instance, the WTRU may involve comparing the RRM prediction closest to the current reporting time with one or more of the following: with any number of predictions associated with future time instances (e.g., the first two, or the last one, etc.); with an aggregate RMM prediction over a window of m future time instances; and/or any combination thereof.

In inter-cell RRM prediction in temporal domain, the WTRU may perform RRM measurements in a given cell. The WTRU may generate RRM predictions for the current and/or future time instances for another (co-located) cell. From the perspective of how the backward-looking and/or forward-looking approach are defined, inter-cell RRM temporal prediction may be similar to inter-frequency prediction with temporal component.

Regarding the evaluation of the RRM predictions generated by the AIML model, similar to temporal domain case B, the WTRU may perform additional RRM measurements to compare against the RRM predictions. Alternatively, the WTRU may employ a non-AIML prediction method and/or compare the AIML-based predictions against that, and against relevant accuracy thresholds, to decide whether the RRM predictions are accurate enough.

The following describe details regarding the content of the measurement report for a given cell and/or beam. These details may extend to include multiple cells and/or beams per cell.

The WTRU may provide two lists of results, one containing the RRM measurement for the current (e.g., reporting) time instance, and another containing RRM measurement predictions for the current and/or future time instances. In the first case, the WTRU may send a measurement list as [measResultₜ_{₀}] and a predictions list as [predResultₜ_{₀}, predResultₜ_{₁}, . . . , predResultₜ_{_{N}}], where measResultₜ_{₀} corresponds to the measured result at the current time instance (t₀) and predResultₜ corresponds to the predicted result at the i-th time instance. Note that t_{N} may correspond to the last prediction within the PW of the AI/ML model, or the last reported value within the configured reporting window, whichever is smaller.

The WTRU may provide a single list with all available RRM measurement results, regardless of whether they are measured or predicted. For example, the WTRU may send the RRM measurement results as [measResultₜ_{₀}, predResultₜ_{₀}, predResultₜ_{₁}, . . . , predResultₜ_{_{N}}]. In such a case, the first entry within the list may correspond to the latest RRM measurement.

The reported results within a list may be of the form: Resultₜ_{ᵢ}=[value, type, addParams]. The value parameter may be an absolute value of the reported quantity (e.g, the reported RSRP value in dBm) or a relative and/or differential value compared to the previous reported value (e.g., the RSRP difference between the current value and the previously reported value). The value parameter may also correspond to an aggregate value, e.g., the average (absolute and/or relative) among the predicted values within the configured reporting window. Finally, the value parameter may be NULL for cases where no available measured data for the current time instance exists (e.g., in frequency domain predictions); there are no predictions for current and/or future time instances; and/or RRM measurement results are available but not statistically significant (or accurate enough) according to the configured thresholds.

The type parameter may be a binary identification parameter (e.g., flag) that signifies whether a reported value corresponds to an RRM measurement or RRM measurement prediction. When a single list may report both measured and predicted results, then the type of parameter may be mandatory to distinguish them. However, when two different lists are used (one for each of the measured and predicted results), then that parameter may become redundant.

The addParams may correspond to additional parameters (optionally) reported together with each reported result. Examples of such parameters may include one or more of the following: KPI metrics, e.g. confidence metrics for future predictions, and/or error metrics for current predictions (based on current measured metrics).

Such parameters may further include reference tags informing about the cause of a reported NULL value, e.g., whether there is no available result (predicted and/or measured) to report. Such other similar instances may include when the result is available but not sufficiently different compared to the previous one based on the configured reporting thresholds, and/or when the RRM prediction is not accurate according to configured accuracy thresholds, etc.

Such parameters may further include additional statistical parameters when the reported result corresponds to an aggregate value, e.g., the standard deviation and/or variance of the RRM measurement results used in the computation of that aggregate value, etc.

For the example solutions described below, assume that the WTRU has already received a measurement configuration, has collected the required RRM measurement results, has determined the necessary reporting periodicity, and/or has determined the top-n cells and/or top-m beams to report. Now, the WTRU may check the RRM measurement results for one of those selected cells. The WTRU may evaluate the statistical significance of those results and/or decide on how to proceed.

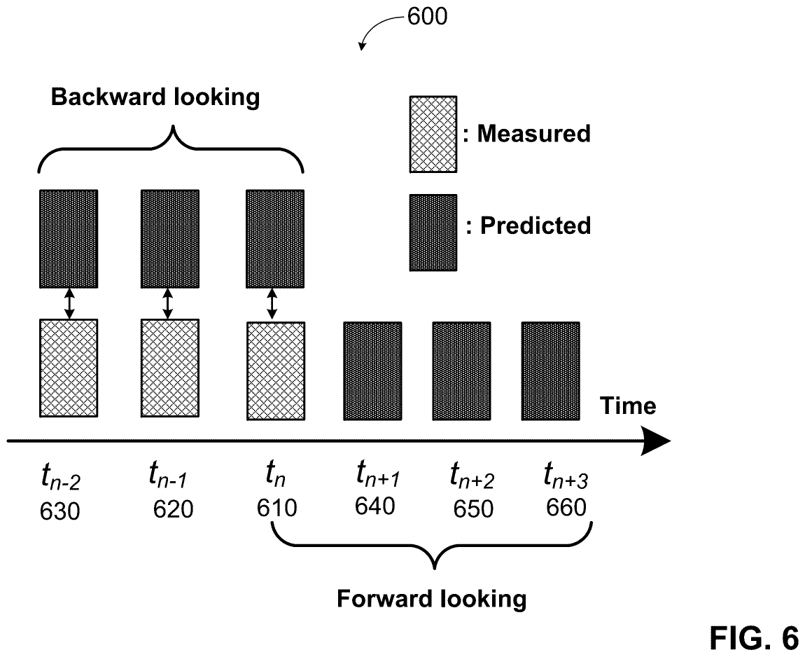

The WTRU may perform RRM predictions in temporal domain according to case A. FIG. 6 depicts the availability of RRM measurements and predictions for the current reporting time of tₙ 610 for cell A 600. As depicted in FIG. 6, for cell A 600, the WTRU may determine the maximum number of time instances to be reported based on the ranking of cell A 600 among the other configured cells. Assuming that cell A 600 is the top cell, the WTRU may report RRM measurement results for up to 2 time instances (for that example).

The WTRU may determine whether to skip the current RRM measurement (at tₙ 610), based on its statistical significance compared to previous RRM measurement results, according to configured thresholds. The WTRU may use an absolute RSRP difference threshold. The WTRU may use such a threshold to compare between the current RRM measurement and the running average of the previous two RRM measurements (at tₙ−1 620 and tₙ−2 630). The current RRM RSRP levels are above that threshold, so the current RRM measurement is statistically different from previous RRM measurements. However, the previous RRM prediction for the current reporting instance is very close to the current RRM measurement, according to another configured threshold (e.g., based on their RSRP difference). As such, the WTRU may determine that the current RRM measurement is not statistically significant to report.

The WTRU may determine whether to include or skip any of the RRM predictions for the future time instances, and in what form, according to their statistical significance compared to the current RRM measurement result. The WTRU may decide that the available RRM predictions for the next three time instances (for tₙ+1 640, tₙ+2 650, and tₙ+3 660) are all statistically significant, as their RSRP difference compared to the current RRM measurement is above the configured threshold. However, since the length of the maximum reporting window is 2 (and shall not be exceeded), the WTRU may report only the first 2 time instances.

The WTRU may send a measurement report containing its RRM predictions for the first 2 time instances, as well as an indication that it has skipped reporting for the current RRM measurement, due to its statistical insignificance.

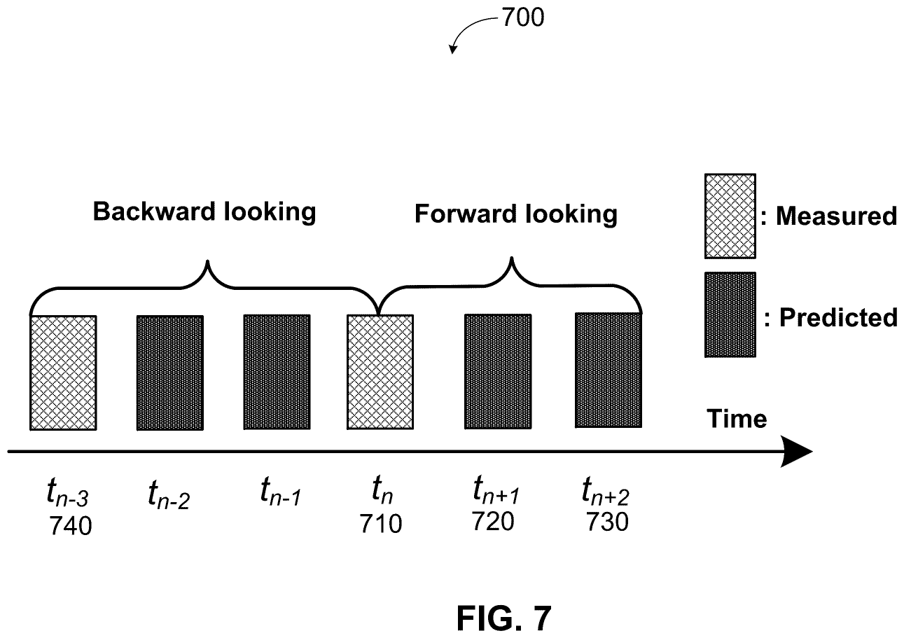

The WTRU may perform RRM predictions in temporal domain according to case B. FIG. 7 depicts the availability of RRM measurements and predictions for the current reporting time of tₙ 710 for cell B 700. The WTRU may determine the maximum number of time instances to report, based on the ranking of cell B 700 among the other configured cells. Assuming that cell B 700 is again the top cell, the WTRU may again report RRM measurement results for up to 2 time instances.

The WTRU may determine whether to skip the current RRM measurement (at tₙ 710 based on its statistical significance compared to previous RRM measurement results, according to configured thresholds. The WTRU may compare the current RRM measurement with the last reported RRM measurement (at tₙ−3 740), forgoing any comparison with previous RRM predictions. As such, the WTRU may gauge that the current RRM measurement offers enough statistical variation according to the configured RSRP difference threshold. The WTRU may determine to include the current RRM measurement in the report.

The WTRU may determine whether to include or skip any of the RRM predictions for the future time instances, and in what form, according to their statistical significance compared to the current RRM measurement result. The WTRU may determine that both RRM predictions (at tₙ+1 720 and/or at tₙ+2 730) are statistically significant compared to the current RRM measurement. The WTRU may determine that the measurements also exhibit enough variation between them, according to the configured (e.g., RSRP difference) threshold. The WTRU may report an aggregate prediction result (e.g., an average), which may include the RRM average among the two available predictions as the second RRM measurement result. In such case, the statistical significance test may also be performed between the RRM average and/or the current RRM measurement.

The WTRU may send a measurement report containing the current RRM measurement and/or the RRM average prediction for the next 2 time instances.

What is claimed is:

1. A wireless transmit/receive unit (WTRU) comprising:
a processor and memory, the processor configured to:
receive reporting configuration information, wherein the reporting configuration information comprises one or more radio resource management (RRM) measurement thresholds associated with RRM measurements, wherein the reporting configuration information comprises one or more RRM measurement prediction thresholds associated with RRM measurement predictions;
determine a plurality of RRM measurements and a plurality of RRM measurement predictions;
determine a reporting periodicity and a reporting offset based on the plurality of RRM measurements, the plurality of RRM measurement predictions, the one or more RRM measurement thresholds, and the one or more RRM measurement prediction thresholds; and
send, based on the reporting periodicity and the reporting offset, a report comprising at least a subset of the plurality of RRM measurements or at least a subset of the plurality of RRM measurement predictions.

2. The WTRU of claim 1, wherein the reporting configuration information comprises an indication of a maximum number of RRM measurements and RRM measurement predictions to include in the report; and wherein the processor is configured to:
determine the subset of the plurality of RRM measurements or the subset of the plurality of RRM measurement predictions based on the indication of the maximum number of RRM measurements and RRM measurement predictions to include in the report.

3. The WTRU of claim 1, wherein the reporting configuration information comprises an indication of a maximum number of cells to report; and
wherein the processor is configured to:
determine a subset of cells to report RRM measurements or RRM measurement predictions based on the maximum number of cells, wherein the subset of the plurality of RRM measurements or the subset of the plurality of RRM measurement predictions are RRM measurements or RRM measurement predictions of the subset of cells.

4. The WTRU of claim 1, wherein the reporting configuration information comprises an indication of a maximum number of beams to report; and
wherein the processor is configured to:
determine a subset of beams to report RRM measurements or RRM measurement predictions based on the maximum number of beams, wherein the subset of the plurality of RRM measurements or the subset of the plurality of RRM measurement predictions are RRM measurements or RRM measurement predictions of the subset of beams.

5. The WTRU of claim 1, wherein the reporting configuration information comprises a cell quality threshold;
wherein the processor is configured to:
determine the subset of the plurality of RRM measurements or the subset of the plurality of RRM measurement predictions based on the cell quality threshold.

6. The WTRU of claim 1, wherein the reporting configuration information comprises a statistical variation of the one or more RMR measurement predictions;
wherein the processor is configured to:
determine the subset of the plurality of RRM measurements or the subset of the plurality of RRM measurement predictions based on the statistical variation of the one or more RMR measurement predictions.

7. The WTRU of claim 1, wherein the reporting configuration information comprises an explicit configuration of the one or more RMR measurements or the one or more RMR measurement predictions;
wherein the processor is configured to:
determine the subset of the plurality of RRM measurements or the subset of the plurality of RRM measurement predictions based on the statistical variation of the one or more RMR measurement predictions.

8. The WTRU of claim 1, wherein the processor is configured to:
indicate an increase in the reporting periodicity when the difference of two or more of the plurality of RRM measurements is greater than the one or more RRM measurement thresholds, or the difference of two or more of the plurality of RRM measurement predictions is greater than one of the one or more RRM measurement prediction thresholds; and
indicate an decrease in the reporting periodicity when the difference of two or more of the plurality of RRM measurements is less than the one or more RRM measurement thresholds, or the difference of two or more of the plurality of RRM measurement predictions is less than one of the one or more RRM measurement prediction thresholds.

9. The WTRU of claim 1, wherein the processor is configured to:
indicate an increase in the reporting offset when the difference of two or more of the plurality of RRM measurements is greater than the one or more RRM measurement thresholds, or the difference of two or more of the plurality of RRM measurement predictions is greater than one of the one or more RRM measurement prediction thresholds; and
indicate an decrease in the reporting offset when the difference of two or more of the plurality of RRM measurements is less than the one or more RRM measurement thresholds, or the difference of two or more of the plurality of RRM measurement predictions is less than one of the one or more RRM measurement prediction thresholds.

10. The WTRU of claim 1, wherein the processor is configured to:
send, with the report, an indication of one or more RMR measurements of the subset of the plurality of RMR measurements and one or more RMR measurement predictions of the subset of the plurality of RMR measurement predictions measurement reporting that were skipped; and
send an indication indicating the reason the reporting of the one or more RMR measurements of the subset of the plurality of RMR measurements and one or more RMR measurement predictions of the subset of the plurality of RMR measurement predictions measurement reporting that were skipped.

11. A method implemented by a wireless transmit/receive unit (WTRU), the method comprising:
receiving reporting configuration information, wherein the reporting configuration information comprises one or more radio resource management (RRM) measurement thresholds associated with RRM measurements, wherein the reporting configuration information comprises one or more RRM measurement prediction thresholds associated with RRM measurement predictions;
determining a plurality of RRM measurements and a plurality of RRM measurement predictions; determine a reporting periodicity and a reporting offset based on the plurality of RRM measurements, the plurality of RRM measurement predictions, the one or more RRM measurement thresholds, and the one or more RRM measurement prediction thresholds; and
sending, based on the reporting periodicity and the reporting offset, a report comprising the at least a subset of the plurality of RRM measurements or at least a subset of the plurality of RRM measurement predictions.

12. The method of claim 11, wherein the reporting configuration information comprises an indication of a maximum number of RRM measurements and RRM measurement predictions to include in the report; and
the method comprising:
determine the subset of the plurality of RRM measurements or the subset of the plurality of RRM measurement predictions based on the indication of the maximum number of RRM measurements and RRM measurement predictions to include in the report.

13. The method of claim 11, wherein the reporting configuration information comprises an indication of a maximum number of cells to report; and
the method comprising:
determining a subset of cells to report RRM measurements or RRM measurement predictions based on the maximum number of cells, wherein the subset of the plurality of RRM measurements or the subset of the plurality of RRM measurement predictions are RRM measurements or RRM measurement predictions of the subset of cells.

14. The method of claim 11, wherein the reporting configuration information comprises an indication of a maximum number of beams to report; and
the method comprising:
determining a subset of beams to report RRM measurements or RRM measurement predictions based on the maximum number of beams, wherein the subset of the plurality of RRM measurements or the subset of the plurality of RRM measurement predictions are RRM measurements or RRM measurement predictions of the subset of beams.

15. The method of claim 11, wherein the reporting configuration information comprises a cell quality threshold;
the method comprising:
determining the subset of the plurality of RRM measurements or the subset of the plurality of RRM measurement predictions based on the cell quality threshold.

16. The method of claim 11, wherein the reporting configuration information comprises a statistical variation of the one or more RMR measurement predictions;
the method comprising:
determining the subset of the plurality of RRM measurements or the subset of the plurality of RRM measurement predictions based on the statistical variation of the one or more RMR measurement predictions.

17. The method of claim 11, wherein the reporting configuration information comprises an explicit configuration of the one or more RMR measurements or the one or more RMR measurement predictions;
the method comprising:
determining the subset of the plurality of RRM measurements or the subset of the plurality of RRM measurement predictions based on the explicit configuration of the one or more RMR measurement predictions.

18. The method of claim 11, the method comprising:
indicating an increase in the reporting periodicity when the difference of two or more of the plurality of RRM measurements is greater than the one or more RRM measurement thresholds, or the difference of two or more of the plurality of RRM measurement predictions is greater than one of the one or more RRM measurement prediction thresholds; and
indicating an decrease in the reporting periodicity when the difference of two or more of the plurality of RRM measurements is less than the one or more RRM measurement thresholds, or the difference of two or more of the plurality of RRM measurement predictions is less than one of the one or more RRM measurement prediction thresholds.

19. The method of claim 11, the method comprising:
indicating an increase in the reporting offset when the difference of two or more of the plurality of RRM measurements is greater than the one or more RRM measurement thresholds, or the difference of two or more of the plurality of RRM measurement predictions is greater than one of the one or more RRM measurement prediction thresholds; and
indicating an decrease in the reporting offset when the difference of two or more of the plurality of RRM measurements is less than the one or more RRM measurement thresholds, or the difference of two or more of the plurality of RRM measurement predictions is less than one of the one or more RRM measurement prediction thresholds.

20. The method of claim 11, the method comprising:
sending, with the report, an indication of one or more RMR measurements of the subset of the plurality of RMR measurements and one or more RMR measurement predictions of the subset of the plurality of RMR measurement predictions measurement reporting that were skipped; and
sending an indication indicating the reason the reporting of the one or more RMR measurements of the subset of the plurality of RMR measurements and one or more RMR measurement predictions of the subset of the plurality of RMR measurement predictions measurement reporting that were skipped.
